(19) United States
(12) Patent Application Publication
(10) Pub. No.: US 2011/0247925 A1
(43) Pub. Date: Oct. 13, 2011

(54) KEYSWITCH MODULE AND KEYBOARD

(76) Inventor: Chin-Hung Lin, Taoyuan (TW)

(21) Appl. No.: 13/080,663

(22) Filed: Apr. 6, 2011

(30) Foreign Application Priority Data
Apr. 7, 2010 (TW) 099206085

(51) Int. Cl. H01H 13/76; H01H 13/02

(52) U.S. Cl. 200/5 A; 200/314

(57) ABSTRACT

A keyswitch module includes a base plate module and a keycap disposed on the base plate module. The base plate module includes a circuit board, a mylar and a light emitting source disposed on the circuit board. The mylar covers the circuit board, a protruding structure protrudes from the mylar, and a hole is formed on the protruding structure. The light emitting source is located in a position corresponding to the protruding structure. A space is formed between the protruding structure and the light emitting source. The keycap includes a transparent structure located in a position corresponding to the hole, wherein the light emitting source emits light to pass through the space, the hole on the protruding structure and the transparent structure of the keycap in sequence.

### BACKGROUND OF THE INVENTION

1. Field of the Invention

The present invention relates to a keyswitch module and a keyboard, and more particularly, to a keyswitch module implemented in an illuminated keyboard.

2. Description of the Prior Art

Recently, with rapid development of information technology industry, a portable electronic device, such as a notebook computer, a smart phone and so on, can be used in various circumstances. As for using a notebook computer in the dark circumstances, it is hard for a user to operate a keyboard since characters marked on the keyswitch might not be visible. Moreover, it might damage the user's sight during the process of using the notebook computer in the dark circumstances. In the prior art, a specific keyswitch equipped with indication light can improve the aforementioned problem. In addition, by various disposals of specific keyswitch equipped with indication light, it makes the portable electronic device equipped with the specific keyboard be able to have different visual effects, so as to enhance the market.

In the prior art, a base plate module of the keyboard with the specific keyswitch capable of emitting indication light includes a circuit board, alight source and a mylar. The light source is disposed on the circuit board, and the mylar covers the light source and the circuit board. In addition, a hole is formed on the mylar and located in a position corresponding to the light source. The keyswitch module is disposed on the mylar, and a keycap of the keyswitch module includes a transparent structure located in a position corresponding to the hole. Accordingly, light emitted from the light source can pass through the hole on the mylar and the transparent structure of the keycap, so as to be detected by the user.

Generally, the mylar is made of polyester resin which is capable of covering the circuit board for positioning the keyswitch module. A resilient component of the keyswitch module can be connected to a side of the mylar, and a switch can be disposed on the circuit board and located in a position corresponding to the resilient component. When the keyswtich module is pressed, the resilient component deforms to actuate the switch. Since the hole on the mylar is located in the position corresponding to the light source, the light emitted from the light source can pass through the mylar via the hole.

Please refer to FIG. 1. FIG. 1 is a diagram of a keyboard 1 in the prior art. As shown in FIG. 1, the keyboard 1 includes a circuit board 10, a light source 12, a mylar 14 and a keyswitch structure 16. The light source is disposed on the circuit board 10, and the mylar 14 covers the circuit board 10 and the light source 12. The light emitted from the light emitted source 12 can pass through a hole 140 on the maylar 14 and a transparent structure 160 of the keyswitch structure 16.

However, the light source 12 emits the light to pass through the hole 140 in different directions (as dotted arrows shown in FIG. 1). Since the light does not travel in substantially one single direction, the light diverges between the keyswitch structure 16 and the mylar 14, so as to generate an inexpectant visual effect.

### SUMMARY OF THE INVENTION

The present invention provides a keyswitch module implemented in an illuminated keyboard for solving above drawbacks.

According to the claimed invention, a keyswitch module includes a base plate module and a keycap disposed on the base plate module. The base plate module includes a circuit board, a mylar and a light emitting source disposed on the circuit board. The mylar covers the circuit board, a protruding structure protrudes from the mylar, and a hole is formed on the protruding structure. The light emitting source is located in a position corresponding to the protruding structure. A space is formed between the protruding structure and the light emitting source. The keycap includes a transparent structure located in a position corresponding to the hole, wherein the light emitting source emits light to pass through the space, the hole on the protruding structure and the transparent structure of the keycap in sequence.

According to the claimed invention, the circuit board is a flexible printed circuit.

According to the claimed invention, the light emitting source is a light emitting diode.

According to the claimed invention, the mylar is made of polyester resin.

According to the claimed invention, the keyswitch module further includes a supporting device connecting the mylar and the keycap for supporting the keycap and a resilient component disposed between the keycap and the mylar.

According to the claimed invention, the keyswitch module further includes a switch disposed on the circuit board and located in a position corresponding to the resilient component. The resilient component actuates the switch when the resilient component deforms as being pressed by the keycap.

According to the claimed invention, a keyboard includes abase plate module and a plurality of keyswitches disposed on the base plate module. The base plate module includes a circuit board, a mylar and a light emitting source disposed on the circuit board. The mylar covers the circuit board, a protruding structure protrudes from the mylar, and a hole is formed on the protruding structure. The light emitting source is located in a position corresponding to the protruding structure. A space is formed between the protruding structure and the light emitting source. Each of the keyswitches includes a keycap with a transparent structure located in a position corresponding to the hole, wherein the light emitting source emits light to pass through the space, the hole on the protruding structure and the transparent structure of the keycap in sequence.

According to the claimed invention, the transparent structure is a lens.

In summary, the mylar of the keyswitch module as well as the keyboard of the present invention has the protruding structure in the position corresponding to the light emitting source. Furthermore, there is a larger space formed between the protruding structure and the light emitting source. As a result, light emitted from the light emitting source with a large deviation angle will be absorbed or reflected by the protruding structure, and only light emitted from the light emitting source with a small deviation angle can pass through the hole of the protruding structure. Accordingly, the light projected from the hole gets more concentrated, so as to prevent an inexpectant visual effect due to light divergence between the keycap and the maylar.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a keyboard in the prior art.

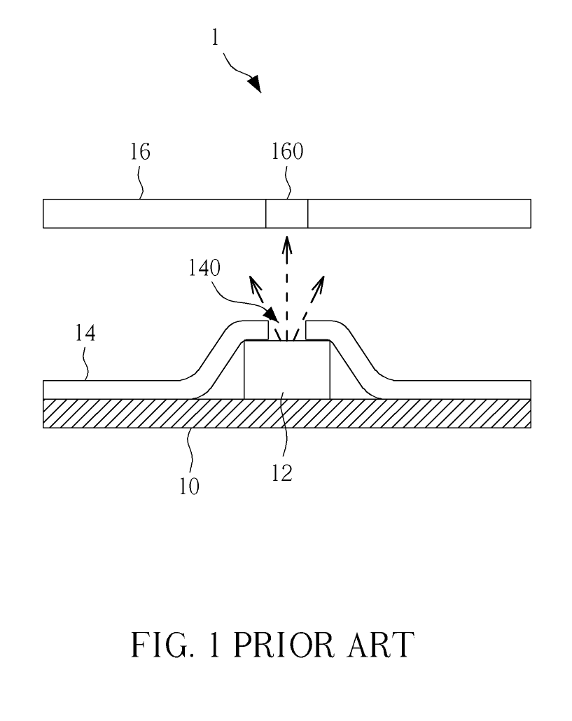

FIG. 2 is a diagram of a keyswitch module according to an embodiment of the present invention.

FIG. 3 is a diagram of a keyswitch module according to another embodiment of the present invention.

FIG. 4 is a diagram of a keyboard according to another embodiment of the present invention.

### DETAILED DESCRIPTION

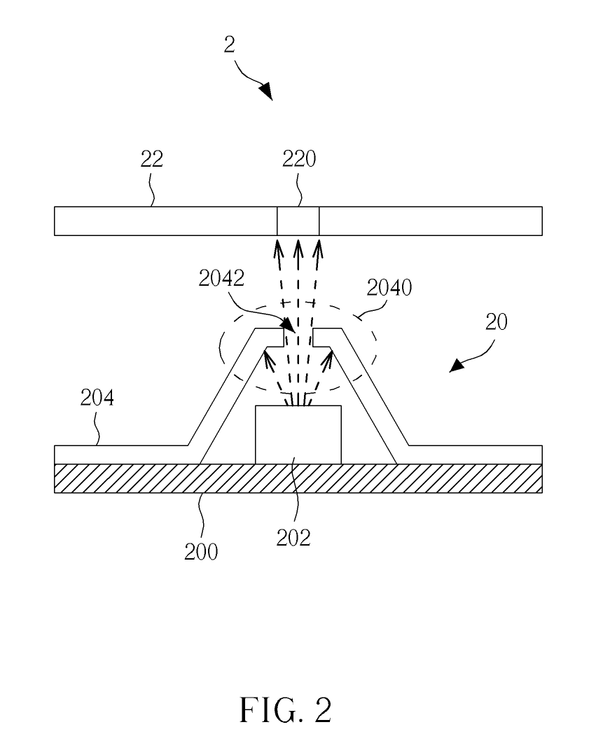

Please refer to FIG. 2. FIG. 2 is a diagram of a keyswitch module 2 according to an embodiment of the present invention. As shown in FIG. 2, the keyswitch module 2 includes a base plate module 20 and a keycap 22. The keycap 22 is disposed on the base plate module 20.

In this embodiment, the base plate module 20 includes a circuit board 200, a light emitting source 202 and a mylar 204. The light emitting source 202 is disposed on the circuit board 200, and the mylar 204 covers the circuit board 200. A protruding structure 2040 protrudes from the mylar 204 and is located in a position corresponding to the light emitting source 202. In addition, a hole 2042 is formed on the protruding structure 2040 for the light emitted from the light emitting source 202 to pass through.

As shown in FIG. 2, the keycap 22 includes a transparent structure 220 located in a position corresponding to the hole 2042 on the protruding structure 2040, so that the light emitted from the light emitting source 202 can pass through the hole 2042 and the transparent structure 220 in sequence. In this embodiment, since the protruding structure 2040 can be punched from an original shape of the mylar 204, a larger space is formed between the protruding structure 2040 and the light emitting source 202. As a result, the light emitted from the light emitting source 202 with a large deviation angle will be projected to a part of the protruding structure 2040 other than the hole 2042 and thus be absorbed or reflected. On the other hand, the light emitted from the light emitting source 202 with a small deviation angle will be projected to and pass through the hole 2042 on the protruding structure 2040. In other words, the light projected from the hole 2042 gets more concentrated without diverging between the keycap 22 and the mylar 204, so as to prevent an inexpectant visual effect.

In practical application, the circuit board 200 can be a flexible printed circuit, the light emitting source 202 can be a light emitting diode, and the mylar 204 can be made of polyester resin. It should be noticed that the present invention is not limited to the aforementioned components, and it depends on design demands.

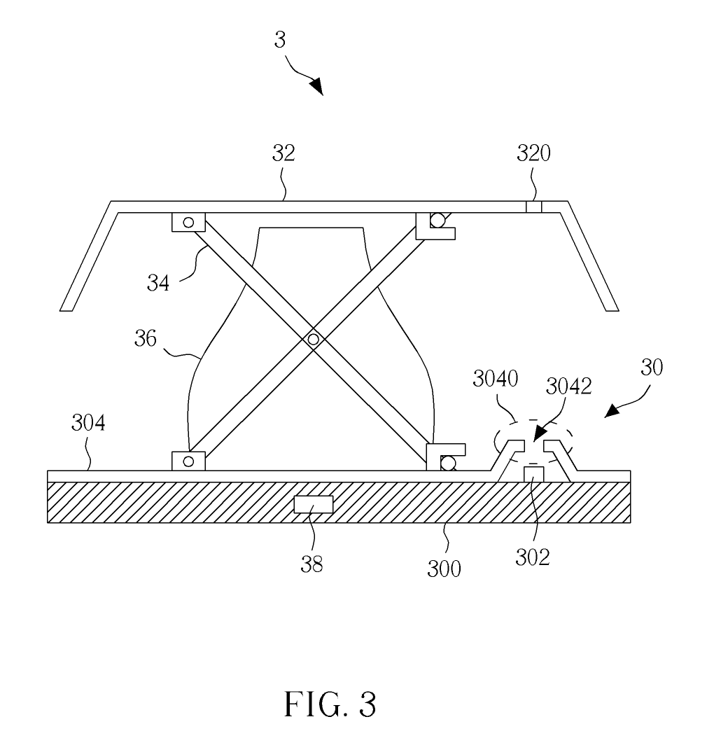

Please refer to FIG. 3. FIG. 3 is a diagram of a keyswitch module 3 according to another embodiment of the present invention. As shown in FIG. 3, the keyswitch module 3 includes a base plate module 30 and a keycap 32. The keycap 32 is disposed on the base plate module 30 and includes a transparent structure 320. The base plate module 30 includes a circuit board 300, a light emitting source 302 and a mylar 304. The light emitting source 302 is disposed on the circuit board 300, and the mylar 304 covers the circuit board 300. A protruding structure 3040 can be punched from the mylar 304 and is located in a position corresponding to the light emitting source 302. In addition, a hole 3042 is formed on the protruding structure 3040 for the light emitted from the light emitting source 302 to pass through. It should be noticed that the base plate module 30 and the keycap 32 in this embodiment are substantially identical to those mentioned in the aforementioned embodiment, so it is not depicted herein for simplicity.

In this embodiment, the keyswitch module 3 further includes a supporting device 34, a resilient component 36 and a switch 38. The supporting device 34 is connected to the keycap 32 and the mylar 304 for supporting the keycap 32 above the mylar 304. The resilient component 36 is disposed between the keycap 32 and the mylar 304 and is connected to the mylar 304. The switch 38 is disposed on the circuit board 300 and located in a position corresponding to the resilient component 36.

When the keycap 32 is pressed, the keycap 32 can be moved toward the mylar 304 by the supporting device 34. The keycap 32 drives the resilient component 36 to deform so as to actuate the switch 38. Accordingly, the circuit board 300 and a processing component (not shown) can determine whether the keycap 32 of the keyswitch module 3 is pressed according to a signal generated by the switch 38 as being actuated.

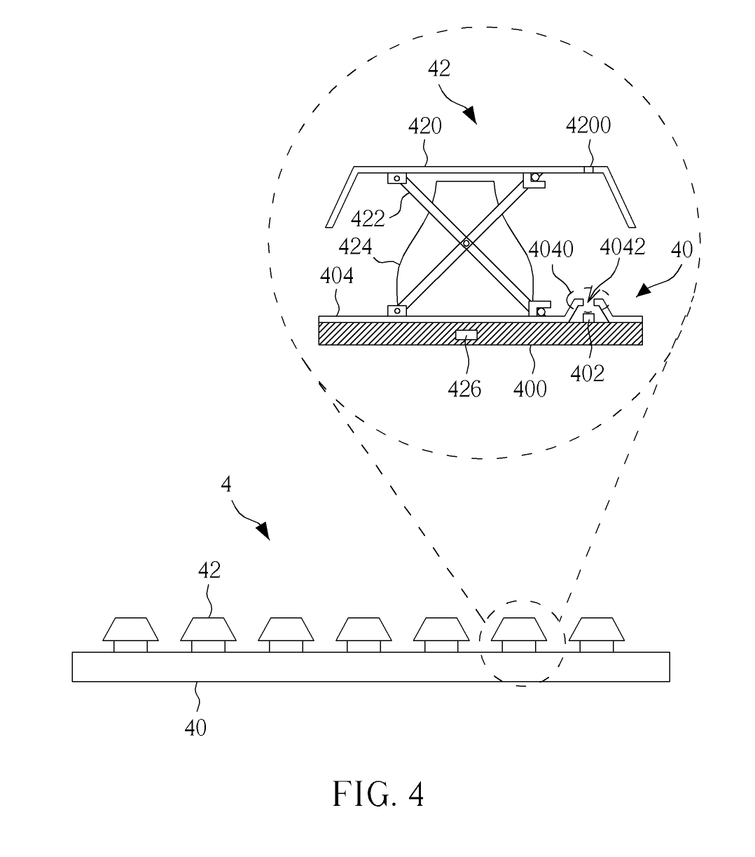

Please refer to FIG. 4. FIG. 4 is a diagram of a keyboard 4 according to another embodiment of the present invention. As shown in FIG. 4, the keyboard 4 includes a base plate module 40 and a plurality of keyswitch modules 42. Each of the keyswitch modules 42 is disposed on the base plate module 40.

The base plate module 40 includes a circuit board 400, a light emitting source 402 and a mylar 404. The light emitting source 402 is disposed on the circuit board 400, and the mylar 404 covers the circuit board 400. A protruding structure 4040 can be punched from the mylar 404 and is located in a position corresponding to the light emitting source 402. In addition, a hole 4042 is formed on the protruding structure 4040 for the light emitted from the light emitting source 402 to pass through.

In practical application, the circuit board 400 can be a flexible printed circuit, the light emitting source 402 can be a light emitting diode, and the mylar 404 can be made of polyester resin. It should be noticed that the present invention is not limited to the aforementioned components, and it depends on design demands.

It should be noticed that the light emitting source 402 is not disposed under every keyswitch module 42, while it is disposed under the keyswitch modules 42 with indication light. Please refer to FIG. 4 again. The keyswitch modules 42 with indication light further includes a keycap 420, a supporting device 422, a resilient component 424 and a switch 426. The keycap 420 includes a transparent structure 4200 located in a position corresponding to the hole 4042 on the protruding structure 4040. The supporting device 420 is connected to the keycap 420 and the mylar 404 for supporting the keycap 420 on the mylar 404. The resilient component 424 is disposed between the keycap 420 and the mylar 404 and is connected to the mylar 404. The switch 426 is disposed on the circuit board 400 and located in a position corresponding to the resilient component 424.

In this embodiment, when the keycap 420 is pressed, the keycap 420 can be moved toward the mylar 404 by the supporting device 422. The keycap 420 drives the resilient component 424 to deform so as to actuate the switch 426. Accordingly, the circuit board 400 and a processing component can determine whether the keycap 420 of the keyswitch module 42 is pressed according to a signal generated by the switch 426 as being actuated.

Since the protruding structure 4040 can be punched from an original shape of the mylar 404, a larger space is formed between the protruding structure 4040 and the light emitting source 402. As a result, the light emitted from the light emitting source 402 with a large deviation angle will be projected to a part of the protruding structure 4040 other than the hole 4042 and thus be absorbed or reflected. On the other hand, the light emitted from the light emitting source 402 with a small deviation angle will be projected to and pass through the hole 2042 on the protruding structure 4040. In other words, the light projected from the hole 4042 gets more concentrated without diverging between the keycap 420 and the mylar 404, so as to prevent an inexpectant visual effect.

It should be noticed that the aforementioned description for the keyswitch module 42 and the corresponding base plate module 40 is illustrated for the keyswitch module 42 with indication light. Other keyswitch modules without indication light do not need to have transparent structures 4200, and neither the light emitting source 402 for emitting indication light nor the protruding structures 4040 is disposed on the corresponding base plate module 40.

Compared with the prior art, the mylar of the keyswitch module as well as the keyboard of the present invention has the protruding structure located in the position corresponding to the light emitting source. Furthermore, there is a larger space formed between the protruding structure and the light emitting source. As a result, light emitted from the light emitting source with a large deviation angle will be absorbed or reflected by the protruding structure, and only light emitted from the light emitting source with a small deviation angle can pass through the hole of the protruding structure. Accordingly, the light projecting out of the hole gets more concentrated, so as to prevent an inexpectant visual effect due to light divergence between the keycap and the maylar.

Those skilled in the art will readily observe that numerous modifications and alterations of the device and method may be made while retaining the teachings of the invention.

What is claimed is:

1. A keyswitch module, comprising:
a base plate module, comprising:
a circuit board;
a mylar covering the circuit board, a protruding structure protruding from the mylar, and a hole being formed on the protruding structure; and
a light emitting source disposed on the circuit board and located in a position corresponding to the protruding structure, a space being formed between the protruding structure and the light emitting source; and
a keycap disposed on the base plate module, the keycap comprising a transparent structure located in a position corresponding to the hole;
wherein the light emitting source emits light to pass through the space, the hole on the protruding structure and the transparent structure of the keycap in sequence.

2. The keyswtich module of claim 1, wherein the circuit board is a flexible printed circuit.

3. The keyswtich module of claim 1, wherein the light emitting source is a light emitting diode.

4. The keyswtich module of claim 1, wherein the mylar is made of polyester resin.

5. The keyswitch module of claim 1, further comprising:
a supporting device connecting the mylar and the keycap for supporting the keycap; and
a resilient component disposed between the keycap and the mylar.

6. The keyswitch module of claim 5, further comprising a switch disposed on the circuit board and located in a position corresponding to the resilient component, the resilient component actuating the switch when the resilient component deforms as being pressed by the keycap.

7. A keyboard, comprising:
a base plate module, comprising:
a circuit board;
a mylar covering the circuit board, a protruding structure protruding from the mylar, and a hole being formed on the protruding structure; and
a light emitting source disposed on the circuit board and located in a position corresponding to the protruding structure, a space being formed between the protruding structure and the light emitting source; and
a plurality of keyswitches disposed on the base plate module, each of the keyswitches comprising a keycap with a transparent structure located in a position corresponding to the hole;
wherein the light emitting source emits light to pass through the space, the hole on the protruding structure and the transparent structure of the keycap in sequence.

8. The keyboard of claim 7, wherein the circuit board is a flexible printed circuit.

9. The keyboard of claim 7, wherein the light emitting source is a light emitting diode.

10. The keyboard of claim 7, wherein the mylar is made of polyester resin.

11. The keyboard of claim 7, wherein the transparent structure is a lens.

12. The keyboard of claim 7, wherein each of the keyswitches comprising:
a supporting device connecting the mylar and the keycap for supporting the keycap; and
a resilient component disposed between the keycap and the mylar.

13. The keyboard of claim 12, wherein the base plate module further comprises a switch disposed on the circuit board and located in a position corresponding to the resilient component, the resilient component actuating the switch when the resilient component deforms as being pressed by the keycap.
